(19) United States
(12) Patent Application Publication
(10) Pub. No.: US 2013/0337355 A1
(43) Pub. Date: Dec. 19, 2013

(54) DIRECT OXIDATION FUEL CELL SYSTEM

(71) Applicant: Masaki Mitsui, Kyoto (JP)

(72) Inventor: Masaki Mitsui, Kyoto (JP)

(73) Assignee: PANASONIC CORPORATION, Osaka (JP)

(21) Appl. No.: 14/002,613

(22) PCT Filed: Sep. 20, 2012
(86) PCT No.: PCT/JP2012/005976

§ 371 Date: Aug. 30, 2013

(30) Foreign Application Priority Data
Nov. 30, 2011 (JP) 2011261400

(51) Int. Cl. H01M 8/04

(52) U.S. Cl. CPC H01M 8/04104
USPC 429/431

(57) ABSTRACT

A direct oxidation fuel cell system including: a fuel cell which generates power from fuel and oxidant gas; a positive displacement pump for supplying the oxidant gas; a power supply for applying drive voltage to the pump; an oxidant gas flow conditioning unit for inhibiting pulsation of discharge pressure of the pump; a pressure sensor for detecting the discharge pressure; a load current sensor for detecting load current of the cell; a voltage sensor for detecting the drive voltage; a first memory for storing first information on a target supply flow rate of the oxidant gas, set based on the load current; a second memory for storing second information on relation of the drive voltage, discharge pressure, and target supply flow rate; and a controller for controlling flow rate of the oxidant gas, by using the informations, and values from the pressure, load current, and voltage sensors.

### TECHINCAL FIELD

The present invention relates to a direct oxidation fuel cell system, and more specifically, to a control system configured to control the amount of oxidant gas supplied to a fuel cell.

### BACKGROUND ART

Fuel cells are becoming commercially available as the power source for automobiles, home cogeneration systems, etc. Recently, studies are also being conducted on use of fuel cells as the power source for small mobile electronic devices such as laptop computers, cellular phones, and personal digital assistants (PDAs). Furthermore, studies are also being conducted on use of fuel cells as the power source for outdoor recreation and emergency backup power. Particularly, since fuel cells can generate power continuously by being refueled, they are expected to be used as the power source for small mobile electronic devices and as portable power sources, and to thereby further improve the convenience thereof.

Among fuel cells, direct oxidation fuel cells (DOFCs) generate electrical energy by directly oxidizing fuel that is liquid at room temperature, without reforming it into hydrogen. Therefore, DOFCs can easily be reduced in size. Direct methanol fuel cells (DMFCs) in particular, which use methanol as fuel, are better in energy efficiency and output power when compared to other direct oxidation fuel cells, and are seen as most promising among DOFCs.

FIG. 9 shows one example of a conventional fuel cell system which includes a DMFC. A fuel cell system 80 of FIG. 6 comprises: a fuel cell 51; a fuel pump 52 for supplying fuel to the fuel cell 51; and an air pump 53 for supplying air, i.e., oxidant gas, to the fuel cell 51. The fuel pump 52 is connected to a dilution tank 54, on the inlet side of the pump. Connected to the dilution tank 54, are a methanol pump 55 and a return pump 56. The methanol pump 55 sends high concentration methanol stored in a methanol tank 57, to the dilution tank 54; whereas the return pump 56 sends liquid separated from gas by a gas-liquid separator 58, to the dilution tank 54.

The gas-liquid separator 58 separates liquid (methanol and water, i.e., an aqueous methanol solution) from a mixture of air, water, unreacted fuel (methanol), carbon dioxide, etc. discharged from the fuel cell 51.

A control unit 59 controls the fuel pump 52, the air pump 53, the methanol pump 55, and the return pump 56. The control unit 59 controls the methanol pump 55 to adjust the amount of the high concentration methanol sent from the methanol tank 57; and controls the return pump 56 to adjust the amount of the aqueous methanol solution sent from the gas-liquid separator 58. This enables the high concentration methanol sent from the methanol tank 57 to be diluted inside the dilution tank 54, such that it turns into an aqueous methanol solution having a methanol concentration of a certain small mass %.

In the fuel cell 51, methanol is supplied to a fuel electrode (anode), and air is supplied to an air electrode (cathode). At the fuel electrode, there is an area called the triple phase boundary where three substances, i.e., a reactant comprising methanol and water, a catalyst (electrode surface), and an electrolyte, are in contact with one another; and on that area, the methanol and water react with one another as represented in the formula (11) given below. By this reaction, carbon dioxide, hydrogen ions, and electrons are produced.

CH₃OH+H₂O→CO₂+6H⁺+6e⁻ (11)

Among the foregoing products, the hydrogen ions (H⁺) pass through a polymer membrane (electrolyte membrane) interposed between the fuel electrode and the air electrode; and the electrons (e⁻) pass through an external load. Both of these products eventually reach the air electrode (cathode). At the air electrode, as represented in the formula (12) given below, oxygen in the air reacts with the hydrogen ions (H⁻) on the triple phase boundary, takes the electrons from the catalyst (electrode surface), and turns into water.

(3/2)O₂+6H⁺+6e⁻→3H₂O (12)

The amount of the water produced by the formula (12) changes according to load variations. As a result, pressure variations occur in an air flow channel in the air electrode. The same applies when water accumulates in the air flow channel in the air electrode.

Here, the air electrode in the fuel cell needs to be supplied with optimum amount of air, in accordance with the power generated. If the amount of the air supplied is too small, water would accumulate on the surface of the electrolyte membrane; and the power generated would be very low. On the contrary, if the amount of the air supplied is too large, the surface of the electrolyte membrane would become dry; and in this case also, the power generated would be very low. When the amount of the air supplied is not appropriate, there would be a loss of balance in water reuse, i.e., in water balance; and the fuel cell would be unable to generate power for long hours.

Therefore, measurement is made on the flow rate of air being supplied to the air electrode, to control the amount of air that is supplied to the air electrode. For example, Patent Literature 1 discloses a control means comprising: detecting the pressure and flow rate of air being supplied to the air electrode; and then adjusting the opening position of the control valve attached to the air supply tube, in accordance with the values obtained from the detections.

Patent Literature 2 discloses a control method comprising: detecting the pressure of air; and then adjusting the opening position of the control valve based on the detection.

Patent Literature 3 discloses a control method comprising: detecting the flow rate of air; and then adjusting the opening position of the control valve based on the detection.

### CITATION LIST

### Patent Literature

[Patent Literature 1] Japanese Laid-Open Patent Publication No. Hei 5-3042

[Patent Literature 2] Japanese Laid-Open Patent Publication No. 2006-210004

[Patent Literature 3] Japanese Laid-Open Patent Publication No. 2006-196203

### SUMMARY OF INVENTION

### Technical Problem

As the foregoing, in a conventional fuel cell system, the flow rate and pressure of air being supplied to the fuel cell are detected; the control valve is controlled based on the detection results; and thus, the flow rate of air supplied to the fuel cell is controlled. However, as in Patent Literatures 1 and 3, in a configuration comprising detecting the flow rate of air being supplied to a fuel cell, a flow rate sensor needs to be connected in series to the fuel cell. Most flow rate sensors have a channel with a small diameter which tend to become clogged with foreign matter. When this causes the flow rate sensor to become clogged with foreign matter, air supplied to the fuel cell becomes insufficient, possibly causing reduction in the amount of power generated by the fuel cell.

For a small-size fuel cell system, use of a positive displacement pump, e.g., a diaphragm pump, as an air supplying device is advantageous in reducing the system in size. However, if such a positive displacement pump is used in the fuel cell system, the reciprocal motion of the diaphragm valve would cause pressure pulsation in the air flow, possibly causing less stability in the power generated by the fuel cell.

Furthermore, as in Patent Literatures 1 to 3, in a configuration which uses a control valve to adjust the amount of air supplied, there would be an increase in production costs due to installation of the control valve, and a necessity to secure space for such installation; and these factors may possibly become obstacles in reducing the system in size.

The present invention is in view of the foregoing problems, and aims to provide a fuel cell system that can prevent a supply line, used therein to supply air to a fuel cell, from becoming clogged, so as to prevent malfunctions from occurring; and that can easily be reduced in size and cost.

### Solution to Problem

To achieve the foregoing aim, one aspect of the present invention relates to a direct oxidation fuel cell system comprising:
a fuel cell configured to generate power from a fuel and an oxidant gas;
a positive displacement pump for supplying the oxidant gas to the fuel cell;
a pump power supply for applying a drive voltage to the pump;
an oxidant gas flow conditioning unit for inhibiting pulsation of a discharge pressure of the pump;
a pressure sensor for detecting the discharge pressure of the pump;
a load current sensor for detecting a load current of the fuel cell;
a voltage sensor for detecting the drive voltage of the pump;
a first memory for storing first information relating to a target supply flow rate of the oxidant gas to be supplied to the fuel cell, the rate set based on the load current (i.e., mapped to the load current);
a second memory 2A for storing second information 2A relating to a relation among the drive voltage of the pump, the discharge pressure of the pump, and the target supply flow rate; and
a controller for controlling a supply flow rate of the oxidant gas being supplied to the fuel cell, the control based on the first information, the second information 2A, a value obtained by the pressure sensor, a value obtained by the load current sensor, and a value obtained by the voltage sensor.

Alternatively, the direct oxidation fuel cell system of the invention may comprise:
a fuel cell stack comprising two or more fuel cells configured to generate power from a fuel gas and an oxidant gas;
a positive displacement pump for supplying the oxidant gas to the fuel cell stack;
an oxidant gas flow conditioning unit for inhibiting pulsation of a discharge pressure of the pump;
a pressure sensor for detecting the discharge pressure of the pump;
a load current sensor for detecting a load current of the fuel cell stack;
a voltage sensor for detecting a voltage of the pump;
a first memory for storing information relating to a target supply flow rate of the oxidant gas to be supplied to the fuel cell stack, the target supply flow rate set based on a value obtained for the load current (i.e., mapped to the load current);
a second memory 2A for storing information relating to a relation among the drive voltage of the pump; the discharge pressure of the pump; and the target supply flow rate; and
a controller for controlling a supply flow rate of the oxidant gas being supplied to the fuel cell stack, the control based on the information stored in the first memory and the information stored in the second memory 2A; and results obtained by the pressure sensor, the load current sensor, and the voltage sensor.

By the foregoing, the oxidant gas can be supplied with stability to the fuel cell, always at an optimum flow rate.

Furthermore, the drive voltage of the pump is preferably controlled, so that the flow rate of the oxidant gas being supplied to the fuel cell matches the target supply flow rate.

Here, the information stored in the second memory 2A is preferably a function represented by an equation (A) as below using the discharge pressure P of the pump and the drive voltage V of the pump, as variables; and using the target supply flow rate as a parameter.

P=a×V−b (A)

In the equation (A), a and b are constants determined by the pump characteristics.

Moreover, another aspect of the invention relates to a direct oxidation fuel cell system comprising:
a fuel cell configured to generate power from a fuel and an oxidant gas;
a positive displacement pump for supplying the oxidant gas to the fuel cell;
a pump power supply for supplying drive current to the pump;
an oxidant gas flow conditioning unit for inhibiting pulsation of a discharge pressure of the pump;
a pressure sensor for detecting the discharge pressure of the pump;
a load current sensor for detecting a load current of the fuel cell;
a pump current sensor for detecting the drive current of the pump;
a first memory for storing first information relating to a target supply flow rate of the oxidant gas to be supplied to the fuel cell, the rate set based on the load current (i.e., mapped to the load current);
a second memory 2B for storing information 2B relating to a relation among the drive current of the pump, the discharge pressure of the pump, and the target supply flow rate; and
a controller for controlling a supply flow rate of the oxidant gas being supplied to the fuel cell, the control based on the first information, the second information 2B, a value obtained by the pressure sensor, a value obtained by the load current sensor, and a value obtained by the pump current sensor.

Alternatively, the fuel cell system of the invention preferably comprises:
a fuel cell stack comprising two or more fuel cells configured to generate power from a fuel gas and an oxidant gas;
a positive displacement pump for supplying the oxidant gas to the fuel cell stack;
an oxidant gas flow conditioning unit for inhibiting pulsation of a discharge pressure of the pump;
a pressure sensor for detecting the discharge pressure of the pump;
a load current sensor for detecting a load current of the fuel cell stack;
a pump current sensor for detecting a current of the pump;
a first memory for storing information relating to a target supply flow rate of the oxidant gas to be supplied to the fuel cell stack, the target supply flow rate set based on a value obtained for the load current (i.e., mapped to the load current);
a second memory 2B for storing information relating to a relation among the drive current of the pump; the discharge pressure of the pump; and the target supply flow rate; and
a control means for controlling a supply flow rate of the oxidant gas being supplied to the fuel cell stack, the control based on the information stored in the first memory and the information stored in the second memory 2B; and results obtained by the pressure sensor, the load current sensor, and the pump current sensor.

By the foregoing, the oxidant gas can be supplied with stability to the fuel cell, always at an optimum flow rate.

Furthermore, the drive current of the pump is preferably controlled, so that the flow rate of the oxidant gas being supplied to the fuel cell matches the target supply flow rate.

Here, the information stored in the second memory 2B is preferably a function represented by an equation (B) as below using the discharge pressure P of the pump and the drive current IP of the pump, as variables; and using the target supply flow rate as a parameter.

P=c×IP−d (B)

In the equation (B), c and d are constants determined by the pump characteristics.

In the case where the load current of the fuel cell stack is equal to or lower than one-half of the rated output current thereof, the target supply flow rate is preferably set to a value equal to the supply flow rate that is optimum when the load current is one-half of the rated output current.

### Advantageous Effects of Invention

According to the present invention, the target supply flow rate is set in accordance with the load current detected by the load current sensor; and therefore, even if there is change in the load current, the oxidant gas could still be supplied to the fuel cell at an optimum flow rate which corresponds to that change.

Moreover, it would be possible to supply the oxidant gas to the fuel cell, always at an optimum flow rate, by using only the pressure sensor, i.e., without having to install a flow rate sensor for detecting the supply flow rate of the oxidant gas being supplied to the fuel cell, or a control valve, etc. for adjusting the foregoing supply flow rate.

Therefore, a fuel cell system can be produced at low cost, and easily be reduced in size.

Moreover, the system can easily be reduced in size, by using the positive displacement pump, e.g., the diaphragm pump, as the device for supplying the oxidant gas. Still moreover, since the oxidant gas flow conditioning unit enables reduction in the pressure pulsation caused by reciprocal motion of the diagphram valve, the power generated by the fuel cell can be made stable.

### BRIEF DESCRIPTION OF DRAWINGS

FIG. 1 is a block diagram schematically showing the structure of a fuel cell system in one embodiment of the present invention.

FIG. 2 is a graph showing information (second information 2A) relating to drive voltage-discharge pressure-air flow rate characteristic of an air pump, the information stored in a memory in the fuel cell system.

FIG. 3 is a flow chart showing a process in controlling the drive voltage of the air pump, the process performed by a control unit in the fuel cell system.

FIG. 4 is a graph showing a relation between a load current and a target supply flow rate that are stored in a memory in the fuel cell system.

FIG. 5 is a flow chart showing a process for setting a value for the target supply flow rate, carried out by the control unit in the fuel cell system.

FIG. 6 is a block diagram schematically showing the sturcture of a fuel cell system in another embodiment of the present invention.

FIG. 7 is a graph showing information (second information 2B) relating to drive current-discharge pressure-air flow rate characteristic of the air pump, the information stored in a memory in the fuel cell system.

FIG. 8 is a flow chart showing a process for contolling the drive current of the air pump, carried out by the control unit in the fuel cell system.

FIG. 9 is a block diagram schematically showing the structure of a conventional fuel cell system.

### DESCRIPTION OF EMBODIMENTS

In the following, an embodiment of the invention will be described with reference to drawings.

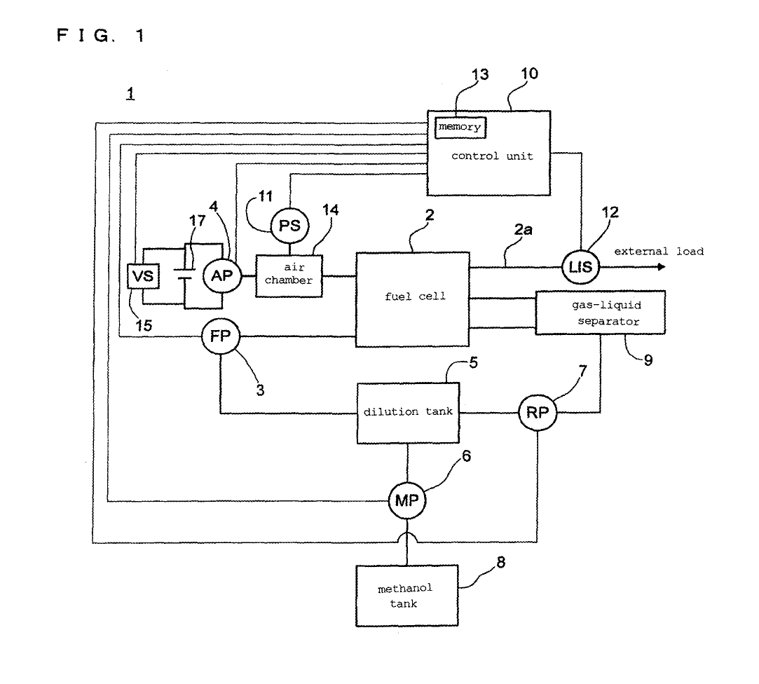

A fuel cell system 1 of FIG. 1 is a power supply system that uses a fuel cell 2 as the power supply source. Here, the fuel cell 2 also applies to a fuel cell stack comprising two or more of unit fuel cells (not shown) configured to generate power from a fuel and an oxidant gas. The fuel cell system 1 comprises: a fuel pump 3 for supplying the fuel to the fuel cell 2; an air pump 4 for supplying air, i.e., the oxidant gas, to the fuel cell 2; and an air chamber 14, i.e., an oxidant gas flow conditioning unit for inhibiting pulsation of a discharge pressure of the air pump 4; and a pressure sensor 11 for detecting the discharge pressure of the air pump 4. The air chamber 14 functions as a buffer chamber for inhibiting pulsation of the discharge pressure of the air pump 4, by temporarily storing the air sent from the air pump 4.

The air pump 4 can be a positive displacement pump. An example of such a positive displacement pump is a diaphragm pump wherein voltage is applied to a piezoelectric device, thereby causing reciprocal motion of a diaphragm valve. The volume of the air chamber 14 is preferably set to a size capable of sufficiently reducing pulsation of the discharge pressure of the air pump 4. For example, the volume is preferably set to a value 0.005 to 0.05 times, and further preferably 0.01 to 0.03 times, the value of the discharge amount per minute of the air pump 4 when the fuel cell system 1 is operated by a rated ouput power.

The fuel pump 3 is connected to a dilution tank 5, on the inlet side of the pump. Connected to the dilution tank 5, are a methanol pump 6 and a return pump 7.

The methanol pump 6 sends a high concentration methanol (concentration equal to or higher than 50%) stored in a methanol tank 8, to the dilution tank 5. Meanwhile, the return pump 7 sends a liquid separated from gas by a gas-liquid separator 9, to the dilution tank 5. The fuel pump 3, the return pump 7, and the methanol pump 6 are either a positive displacement pump or a non-positive displacement pump.

The gas-liquid separator 9 includes a gas-liquid separation film (not shown) which is for separating a liquid (methanol and water, i.e., an aqueous methanol solution) from a mixture of air, water, unreacted fuel (methanol), carbon dioxide, etc. released from the fuel cell 2.

Here, the fuel pump 3, the air pump 4, the methanol pump 6, and the return pump 7 are controlled by a control unit 10 (controller) comprising, e.g., a one-chip microcomputer. The control unit 10 controls the methanol pump 6 and the return pump 7, thereby adjusting the amount of the methanol to be sent from the methanol tank 8 and the amount of the aqueous methanol solution to be sent from the gas-liquid separator 9. This enables production of an aqueous methanol solution with an appropriate methanol concentration (of a small mass %), in the dilution tank 5.

The fuel pump 3 sends the aqueous methanol solution produced in the dilution tank 5 to the fuel cell 2, according to a command from the control unit 10. Likewise, the air pump 4 sends the air to the fuel cell 2 via the air chamber 14, according to a command from the control unit 10.

The pressure sensor 11 is connected to the air chamber 14, so as to detect the pressure in the air chamber 14, so as to detect the discharge pressure of the air pump 4. A value obtained by the pressure sensor 11 (detected pressure Pd) is entered into the control unit 10. Moreover, a load current sensor 12 which detects the output current (load current) of the fuel cell 2, is provided on a power supply line 2a through which power is supplied from the fuel cell 2 to an external load. A value obtained by the load current sensor 12 (detected load current ILd) is also entered into the control unit 10.

In the following, a method for control in the present embodiment will be described in detail.

The fuel cell system 1 is provided with an air pump power supply 17 which is a power source used to supply power to the air pump 4. The air pump power supply 17 may include, e.g., a power storage device which stores power generated by the fuel cell 2. The fuel cell system 1 is further provided with a voltage sensor 15 which detects a drive voltage of the air pump 4, i.e., a drive voltage that is applied to the air pump 4 by the air pump power supply 17. The voltage sensor 15 can be connected in parallel with the air pump power supply 17. A value obtained by the voltage sensor 15 (detected pump voltage Vd) is entered into the one-chip microcomputer in the control unit 10.

To prevent the power output of the fuel cell 2 from decreasing due to load variation, etc., the control unit 10 controls the flow rate of the air being supplied to the fuel cell 2, so that it is appropriate, by adjusting the voltage of the air pump 4 based on the following: the respective values obtained by the pressure sensor 11, the load current sensor 12, and the voltage sensor 15; and information stored in advance in a memory 13 which is an auxiliary storage unit made of, e.g., a flash memory in a one-chip microcomputer, etc.

Here, the memory 13 stores information relating to the following factors of the air pump 4: the drive voltage, the discharge pressure, and a target supply flow rate Q of the air (oxidant gas) to be supplied to the fuel cell 2. That is, it stores information (second information 2A) relating to the drive voltage-discharge pressure-target supply flow rate characteristic of the air pump 4. The memory 13 also stores information (first information) relating to the load current-target supply flow rate characterstic of the fuel cell 2.

More specifically, the control unit 10 refers to the information relating to the load current-target supply flow rate characteristic of the fuel cell 2, stored in the memory 13 (c.f., FIG. 4 to be described later) in advance; and sets the target supply flow rate Q, based on the load current detected by the load current sensor 12 (detected load current ILd). Moreover, the control unit 10 refers to the information (second information 2A) relating to the drive voltage-discharge pressure-target supply flow rate characteristic of the air pump 4, stored in the memory 13 in advance; and controls the drive voltage of the air pump 4, so that the actual air supply flow rate of the air pump 4 becomes equal to the target supply flow rate Q. As such, the memory 13 includes a first memory and a second memory 2A.

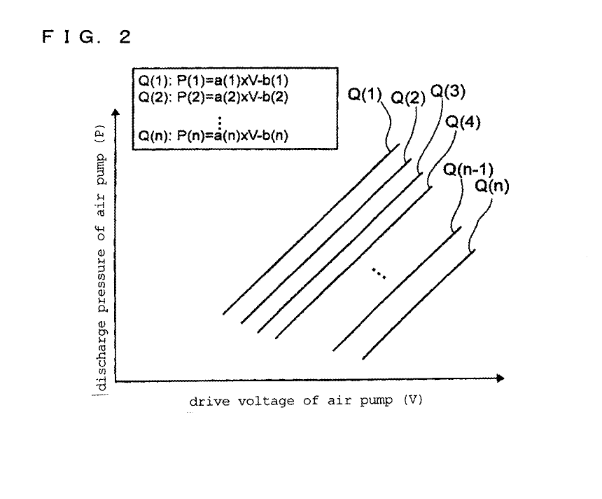

FIG. 2 shows an example of the information (second information 2A) relating to the drive voltage-discharge pressure-target supply flow rate characteristic of the air pump 4, stored in the memory 13 in advance. The second information 2A includes a group of graphs (drive voltage-discharge pressure characteristic curves) or functions. Each of them represents a relation between the driving voltage and discharge pressure of the air pump 4; and uses the target supply flow rates Q(1), Q(2), Q(3), . . . , Q(n) as parameter values, the rates determined according to the load current. That is, the functions each show the relation between the following factors: the discharge pressure of the air pump 4, with which the target supply flow rate Q(k) is obtained; and the drive voltage of the air pump 4, with which the discharge pressure is obtained. With respect to the target supply flow rate Q(k), in the example shown in FIG. 2, Q(1), Q(2), Q(3), . . . , and Q(n) relate to one another as Q(1)<Q(2)<Q(3)< . . . <Q(n). Here, the value of n is made as large as possible, so that the target supply flow rate Q(k) matches the optimum supply flow rate.

In the memory 13, equations representing the voltage-discharge pressure characterstic curves corresponding to the target supply flow rates Q(1), Q(2), Q(3), . . . , Q(n), respectively, are stored in advance. The following equation (1) represents the driving voltage-discharge pressure characteristic curve corresponding to the k^{th} (k:k=1, 2, . . . , n) target supply flow rate Q(k).

P(k)=a(k)×V−b(k) (1)

In the foregoing equation (1), P(k) is the discharge pressure of the air pump; V is the drive voltage of the air pump; b(k) is a virtual discharge pressure of the air pump when the voltage of the air pump is “0”; and a(k) is a constant determined based on the characteristics of the air pump. Note that a value for b(k) is also determined based on the characteristics of the air pump.

The control unit 10 makes a comparison between the following: the value of the discharge pressure (detected pressure Pd) of the air pump 4, obtained by the pressure sensor 11; and the discharge pressure (calculated pressure P(k)) calculated by the equation (1), based on the drive voltage V (here, detected voltage Vd) of the air pump 4 at that point in time. Then, the control unit 10 adjusts the drive voltage V so that the detected pressure Pd and the calculated pressure P(k) converge to the same value. The adjustment of the drive voltage V can be made by, e.g., transforming the output voltage of the air pump power supply 17 with use of a DC/DC converter or DC/AC inverter. The voltage conversion ratio for the DC/DC converter or DC/AC inverter can be determined, by the control unit 10 setting the duty ratio through PWM control. Thus, the air supply flow rate of the air pump 4 becomes equal to the target supply flow rate Q(k).

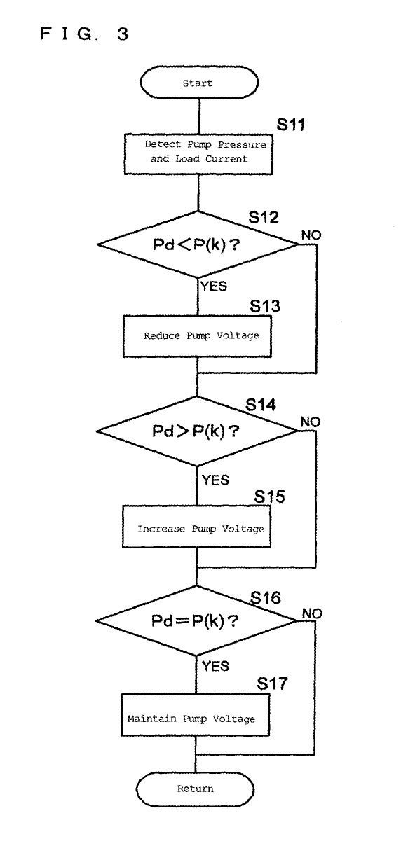

FIG. 3 is a flow chart showing the foregoing process for controlling the air supply flow rate, carried out by the control unit 10.

In FIG. 3, first, the discharge pressure and load current of the air pump 4 are detected by the pressure sensor 11; and are entered as the detected pressure Pd and detected load current ILd, respectively, into the control unit 10 (step S11). Next, the target supply flow rate Q(k) is set based on the detected load current ILd. In accordance with the target supply flow rate Q(k) that has been set, the calculated pressure P(k) is calculated by the foregoing equation (1) based on the drive voltage (detected voltage Vd) of the air pump 4 at that point in time. Then, it is determined whether or not the detected pressure Pd is smaller than the calculated pressure P(k) (step S12). Here, if the detected pressure Pd is smaller than the calculated pressure P(k), a step S13 follows; and if equal to or greater than the calculated pressure P(k), a step S14 follows.

In the step S13, the calcuated pressure P(k) is reduced to the detected pressure Pd; and, to obtain the target supply flow rate that has been set as the foregoing, the drive voltage V of the air pump 4 is reduced by a predetermined amount due to a command from the control unit 10. Thereafter, the step S14 follows. The percentage reduction of the calcuated P(k) when the drive voltage V is reduced, is greater than the percentage reduction of the acutal discharge pressure P (detected pressure Pd) of the air pump 4; and therefore, by reducing the drive voltage V, a match can be made between the calcuated pressure and the actual pressure.

In the step S14, in accordance with the target supply flow rate Q(k), the detected pressure Pd is determined whether or not it is greater than the calculated pressure P(k) that has been calculated by the foregoing equation (1) based on the drive voltage V (detected voltage Vd) of the air pump 4 at that point in time. Here, if the detected pressure Pd is greater than the calculated pressure P(k), a step S15 follows; and if equal to or smaller than the calculated pressure P(k), a step S16 follows.

In the step S15, the calculated pressure P(k) is increased to the detected pressure Pd; and, to obtain the target supply flow rate Q(k) that has been set as the foregoing, the drive voltage V of the air pump 4 is increased by the predetermined amount as the foregoing, due to a command from the control unit 10. Thereafter, a step S16 follows. The percentage increase of the calculated pressure P(k) when the drive voltage V is increased, is greater than the percentage increase of the acutal discharge pressure P (detected pressure Pd) of the air pump 4; and therefore, by increasing the drive voltage V, a match can be made between the calculated pressure and the actual pressure.

In the step S16, in accordance with the target supply flow rate Q(k), the detected pressure Pd is determined whether or not it is equal to the calculated pressure P(k) that has been calculated based on the drive voltage V at that point in time. Here, if the detected pressure Pd is equal to the calculated pressure P(k), the acutal supply flow rate of the air to the fuel cell 2 is determined as matching the target supply flow rate Q(k), and a step S17 follows. In the step S16, if the detected pressure Pd is not equal to the calculated pressure P(k), the process reverts back to the step S11.

In the step S17, the drive voltage V of the air pump 4 is maintained, and the process reverts back to the step S1.

Next, a description will be given on setting the target supply flow rate in accordance with the load current. FIG. 4 is a graph showing the load current-target supply flow rate characteristic, i.e., the information (first information) relating to the target supply flow rate of the air to be supplied to the fuel cell 2. The target supply flow rate is set according to the value of the load current.

Since the optimum air supply flow rate is proportional to the output current (load current) of the fuel cell 2, the target supply flow rate Q is set based on the foregoing output current. For example, supposing that a rated output current of the fuel cell 2 is INL and the optimum air supply flow rate at that point in time is Q(3), if the load current is equal to or smaller than 0.5×INL (one-half of the rated output current I, the target supply flow rate is set to Q(1) which is one-half of Q(3). If the load current is greater than 0.5×INL, and equal to or smaller than 0.75×INL (three-fourth of the rated output current INL), the target supply flow rate is set to Q(2) which is three-fourth of Q(3).

As the foregoing, by setting the target supply flow rate so that it increases stepwise as the load current increases, the amount of data to be stored in the memory 13 can be reduced.

However, in terms of making the target supply flow rate match the optimum air supply flow rate as much as possible, the number (n) set for the target supply flow rate is preferably made as large as possible.

Here, the target supply flow rate Q(1) is set to a fixed value when the load current is equal to or smaller than 0.5×INL, due to the following reason. If the air supply flow rate is reduced when the load current is comparatively small, water generated at the air electrode would completely clog the air flow channel, and this may cause significant reduction in the voltage that is generated. Note that the range of the load current, in which the target supply flow rate is required to be set to a fixed value, is not limited to be equal to or smaller than 0.5×INL, and is preferably determined in view of factors such as clogging of the flow channel due to water generated at the air electrode, etc.

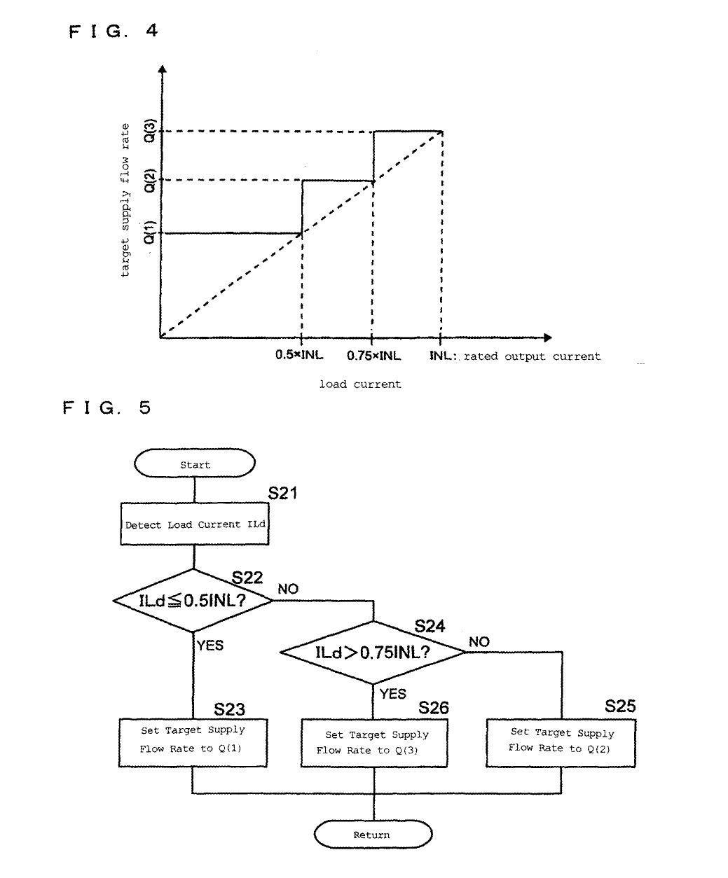

In the following, with reference to a flowchart shown in FIG. 5, a description will be given on a process carried out by the control unit 10, for setting the target supply flow rate Q(k) by using the information (first information) shown in FIG. 4.

As shown in FIG. 5, first, the load current sensor 12 detects the load current of the fuel cell 2 (step S21). Next, the detected load current (detected load current ILd) is determined whether or not it is equal to or smaller than 0.5×INL (step S22). Here, if the detected load current ILd is equal to or smaller than 0.5×INL, a step S23 follows; and after the target supply flow rate is set to Q(1), the process reverts back to the step S21. Alternatively, if the detected load current ILd is greater than 0.5×INL, a step S24 follows.

In the step S24, the detected load curent ILd is determined whether or not it is greater than 0.5×INL, and also equal to or smaller than 0.75×INL. That is, the detected load current ILd is determined whether or not it is greater than 0.75×INL, and if not (NO at S24), it is determined as being within the foregoing range, and a step S25 follows; and after the target supply flow rate is set to Q(2), the process goes back to the step S21. Alternatively, if the detected load current ILd is not within the foregoing range (YES at S24), it is determined as being greater than 0.75×INL, and a step S26 follows. In the step S26, the target supply flow rate is set to Q(3), and the process reverts back to the step S21.

As described in the foregoing, according to the present embodiment, the fuel cell system 1 is easily reduced in size by using a positive displacement pump for the air pump 4. Moreover, by allowing the air discharged from the air pump 4 to be supplied to the fuel cell 2, via the air chamber 14 serving as a buffer chamber, the oxidant gas can be supplied with stability to the fuel cell 2, always at an optimum flow rate; and stable power can be generated by the fuel cell 2.

Moreover, since the target supply flow rate is set in accordance with the load current detected by the load current sensor 12, even if the load current changes, the oxidant gas can be supplied to the fuel cell at an optimum flow rate in accordance with that change.

Still moreover, the oxidant gas can be supplied to the fuel cell 2, always at an optimum flow rate, by using only the pressure sensor 11, i.e., without having to install a flow rate sensor for the flow rate of the oxidant gas being supplied to the fuel cell 2, or a control valve for adjusting the foregoing flow rate. Thus, the fuel cell system can be provided at low cost, and easily reduced in size. Furthermore, malfunctions caused by clogging of the flow rate sensor, etc. can be prevented from occurring, and the fuel cell system 1 can be operated with stability.

Next, another embodiment of the present invention will be described.

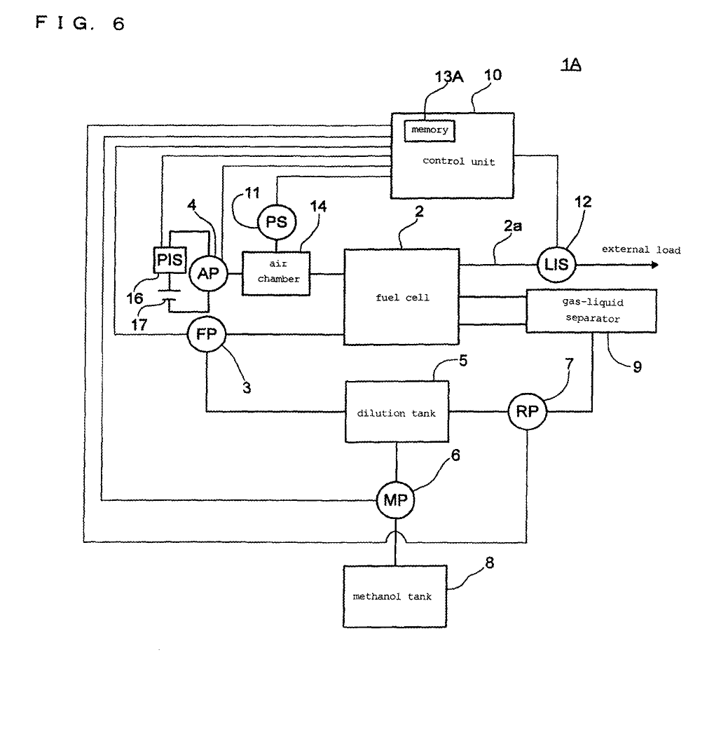

FIG. 6 is a block diagram showing a fuel cell system according to another embodiment of the present invention. A fuel cell system 1A shown in FIG. 6 differs from the system shown in FIG. 1, in that it includes a pump current sensor 16 for detecting a current of the air pump power supply 17 which supplies power to the air pump 4, i.e., a drive current IP of the air pump 4. The pump current sensor 16 can be connected in series with the air pump power supply 17. The value of the current detected by the pump current sensor 16 (detected pump current IPd) is entered into the one-chip microcomputer in the control unit 10.

To prevent the power output of the fuel cell 2 from decreasing due to load variation, etc., the control unit 10 controls the flow rate of the air supplied to the fuel cell 2, so that it is appropriate, by adjusting the drive current IP of the air pump 4 based on the following: the respective values obtained by the pressure sensor 11, the load current sensor 12, and the pump current sensor 16; and information stored in advance in a memory 13A which is an auxiliary storage unit made of, e.g., a flash memory in a one-chip microcomputer, etc.

The memory 13A stores information relating to the following factors of the air pump 4: the drive current (detected pump current IPd), the discharge pressure (detected pressure Pd), and the target supply flow rate Q of the air (oxidant gas) to be supplied to the fuel cell 2. That is, it stores information (second information 2B) relating to the drive current-discharge pressure-target supply flow rate characteristic of the air pump 4. The memory 13A also stores information (first information) relating to the load current-target supply flow rate characterstic of the fuel cell 2. As such, the memory 13A includes a first memory and a second memory 2B.

More specifically, the control unit 10 refers to the information relating to the load current-target supply flow rate characteristic of the fuel cell 2, stored in the memory 13A (c.f., first information, FIG. 4) in advance; and sets the target supply flow rate Q, based on the load current of the fuel cell 2 detected by the load current sensor 12 (detected load current ILd). Moreover, the control unit 10 refers to the information (second information 2B) relating to the drive current-discharge pressure-target supply flow rate characteristic of the air pump 4, stored in the memory 13A in advance; and controls the drive current of the air pump 4, so that the actual air supply flow rate of the air pump 4 equals the target supply flow rate Q.

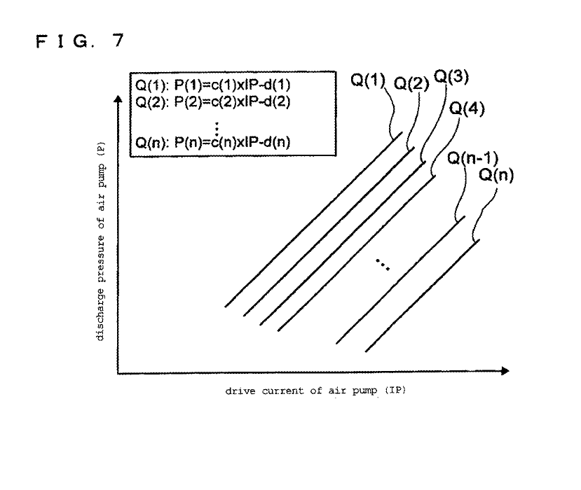

FIG. 7 shows an example of the information (second information 2B) relating to the drive current-discharge pressure-target supply flow rate characteristic of the air pump 4, stored in the memory 13A in advance. The second information 2B includes a group of graphs (drive current-discharge pressure characteristic curves) or functions. Each of them represents the relation between the driving current and discharge pressure of the air pump 4; and uses the target supply flow rates Q(1), Q(2), Q(3), Q(n) as parameter values, the rates determined according to the load current of the fuel cell 2. That is, the functions each show a relation between the following factors: the discharge pressure of the air pump 4, with which the target supply flow rate Q(k) is obtained; and the drive current of the air pump 4, with which the discharge pressure is obtained. With respect to the target supply flow rate Q(k), in the example shown in FIG. 7, Q(1), Q(2), Q(3), . . . , and Q(n) relate to one another as Q(1)<Q(2)<Q(3)< . . . <Q(n). Here, the value of n is made as large as possible, so that the target supply flow rate Q(k) matches the optimum supply flow rate.

In the memory 13A, equations representing the current-discharge pressure characterstic curves corresponding to the target supply flow rates Q(1), Q(2), Q(3), . . . , Q(n), respectively, are stored in advance. The following equation (2) represents the current-discharge pressure characteristic curve corresponding to the k^{th} (k:k=1, 2, . . . , n) target supply flow rate Q(k).

P(k)=c(k)×IP−d(k) (2)

In the foregoing equation (2), P(k) is the discharge pressure of the air pump; IP is the drive current of the air pump; d(k) is a virtual discharge pressure of the air pump when the current of the air pump is “0”; and c(k) is a constant determined based on the characteristics of the air pump. Note that a value for d(k) is also determined based on the characteristics of the air pump.

The control unit 10 makes a comparison between the following: the value of a discharge pressure (detected pressure Pd) of the air pump 4, obtained by the pressure sensor 11; and the discharge pressure (calculated pressure P(k)) calculated by the equation (2), based on the drive current (here, detected pump current IPd) of the air pump 4 at that point in time. Then, the control unit 10 adjusts the drive current IP of the air pump 4 so that the detected pressure Pd and the calculated pressure P(k) converge to the same value. The adjustment of the drive current IP can be made by, e.g., transforming the output voltage of the air pump power supply 17 with use of a DC/DC converter or DC/AC inverter. This is because, when the output voltage is transformed, the output current also changes in accordance with the transformation. The voltage conversion ratio for the DC/DC converter or DC/AC inverter can be determined, by the control unit 10 setting the duty ratio through PWM control. Thus, the air supply flow rate of the air pump 4 becomes equal to the target supply flow rate Q(k).

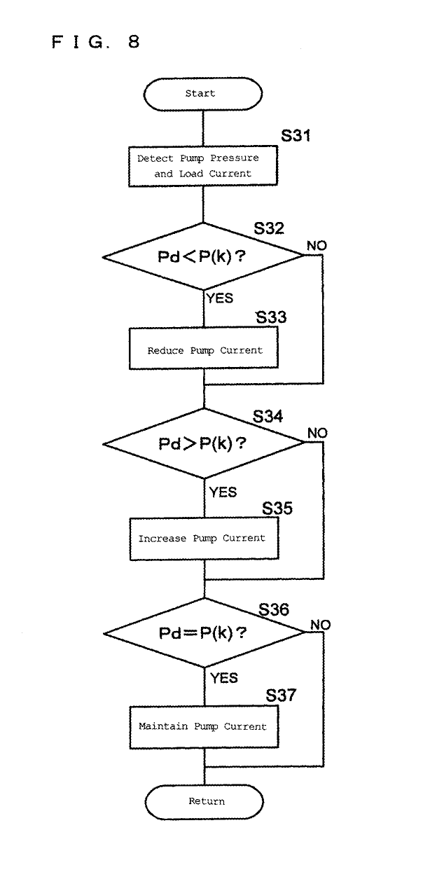

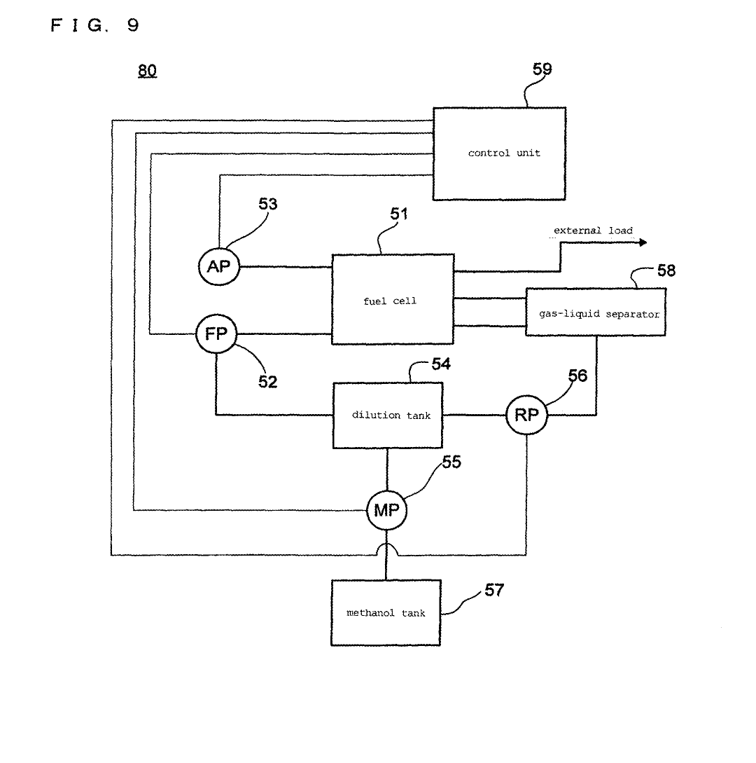

FIG. 8 is a flow chart showing the foregoing process for controlling the air supply flow rate, carried out by the control unit 10.

In FIG. 8, first, the discharge pressure of the air pump 4 and load current are detected by the pressure sensor 11; and are entered as the detected pressure Pd and detected load current ILd, respectively, into the control unit 10 (step S31). Next, the target supply flow rate Q(k) is set based on the detected load current ILd. In accordance with the target supply flow rate Q(k) that has been set, the calculated pressure P(k) is calculated by the foregoing equation (2) based on the drive current (detected pump current IPd) of the air pump 4 at that point in time. Then, it is determined whether or not the detected pressure Pd is smaller than the calculated pressure P(k) (step S32). Here, if the detected pressure Pd is smaller than the calculated pressure P(k), a step S33 follows; and if equal to or greater than the calculated pressure P(k), a step S34 follows.

In the step S33, the calcuated pressure P(k) is reduced to the detected pressure Pd; and, to obtain the target supply flow rate that has been set as the foregoing, the drive current IP of the air pump 4 is reduced by a predetermined amount due to a command from the control unit 10. Thereafter, the step S34 follows. The percentage reduction of the calcuated P(k) when the drive current IP is reduced, is greater than the percentage reduction of the acutal discharge pressure P (detected pressure Pd) of the air pump 4; and therefore, by reducing the drive current IP, a match can be made between the calcuated pressure and the actual pressure.

In the step S34, in accordance with the target supply flow rate Q(k), the detected pressure Pd is determined whether or not it is greater than the calculated pressure P(k) that has been calculated by the foregoing equation (2) based on the drive current IP of the air pump 4 at that point in time. Here, if the detected pressure Pd is greater than the calculated pressure P(k), a step S35 follows; and if equal to or smaller than the calculated pressure P(k), a step S36 follows.

In the step S35, the calculated pressure P(k) is increased to the detected pressure Pd; and, to obtain the target supply flow rate Q(k) that has been set, the foregoing current of the air pump 4 is increased by the predetermined amount by the control unit 10. Thereafter, a step S36 follows. The percentage increase of the calculated pressure P(k) when the drive current IP is increased, is greater than the percentage increase of the acutal discharge pressure P (detected pressure Pd) of the air pump 4; and therefore, by increasing the drive current IP, a match can be made between the calculated pressure and the actual pressure.

In the step S36, in accordance with the target supply flow rate Q(k), the detected pressure Pd is determined whether or not it is equal to the calculated pressure P(k) that has been calculated based on the drive current IP at that point in time. Here, if the detected pressure Pd is equal to the calculated pressure P(k), the acutal supply flow rate of the air supplied to the fuel cell 2 is determined as matching the target supply flow rate Q(k), and a step S37 follows. If the detected pressure Pd is not equal to the calculated pressure P(k), the process reverts back to the step S31.

In the step S37, the drive current IP of the air pump 4 is maintained, and the process reverts back to the step S31. The target supply flow rate Q(k) can be set in the same manner as for the first embodiment (c.f., FIGS. 4 and 5).

As the foregoing, in the fuel cell systems of the first and second embodiments, the driving voltage or current of the air pump 4 is increased or reduced based on the value obtained by the pressure sensor 11, so that the actual flow rate of the air supplied to the fuel cell 2 by the air pump 4 becomes equal to the target supply flow rate Q.

Therefore, since it would not be necessary to install a flow rate sensor for detecting the flow rate of the air supplied to the fuel cell 2 by the air pump 4, or to install an air control valve, air adjusting valve, etc. for adjusting the flow rate of the air supplied thereto, it would be possible to reduce the production cost of the fuel cell system and to easily reduce the size of the devices used therein.

Moreover, since it would not be necessary to install a flow rate sensor requiring connection in series with the fuel cell 2, it would be possible to prevent occurrences of malfunctions caused by cloggings of such a flow rate sensor. Still moreover, the air chamber 14 would reduce pressure pulsation caused by reciprocal motion of a diaphragm valve; and thus, stable power would be generated by the fuel cell 2.

### INDUSTRIAL APPLICABILITY

The fuel cell system of the present invention is excellent in terms of improving production costs and space factors, and solving the problem whereby the channel of the flow rate sensor is clogged with foreign matter. For example, the fuel cell system is useful as the power source for small mobile electronic devices wuch as laptop computers, cellular phones, and personal digital assistants (PDAs), and the power source for outdoor recreation and emergency backup. Furthermore, the fuel cell system of the present invention can be applied for use as the power source for electric scooters, etc.

### EXPLANATION OF REFERENCE NUMERALS

1, 1A: fuel cell system

2: fuel cell

3: fuel pump

4: air pump

5: dilution tank

6: methanol pump

7: return pump

8: methanol tank

9: gas-liquid separator

10: control unit

11: pressure sensor

12: load current sensor

13, 13A: memory

14: air chamber

15: pressure sensor

16: pump curent sensor

17: air pump power supply

1. A direct oxidation fuel cell system comprising:
a fuel cell configured to generate power from a fuel and an oxidant gas;
a positive displacement pump for supplying the oxidant gas to the fuel cell;
a pump power supply for applying a drive voltage to the pump;
an oxidant gas flow conditioning unit for inhibiting pulsation of a discharge pressure of the pump;
a pressure sensor for detecting the discharge pressure of the pump;
a load current sensor for detecting a load current of the fuel cell;
a voltage sensor for detecting the drive voltage of the pump;
a first memory for storing first information relating to a target supply flow rate of the oxidant gas to be supplied to the fuel cell, the rate set based on the load current;
a second memory 2A for storing second information 2A relating to a relation among the drive voltage of the pump, the discharge pressure of the pump, and the target supply flow rate; and
a controller for controlling a supply flow rate of the oxidant gas being supplied to the fuel cell, the control based on the first information, the second information 2A, a value obtained by the pressure sensor, a value obtained by the load current sensor, and a value obtained by the voltage sensor.

2. The direct oxidation fuel cell system in accordance with claim 1,
wherein the controller adjusts the drive voltage of the pump, such that a value calculated for the discharge pressure of the pump matches with the value obtained by the pressure sensor,
the calculation comprising: setting the target supply flow rate based on the load current, with use of the first information; and then calculating the value for the discharge pressure, based on the target supply flow rate that is set, with use of the second information 2A.

3. The direct oxidation fuel cell system in accordance with claim 1, wherein a relation between P and V is represented by a function P=a×V−b, where a and b are constants,
P indicating the discharge pressure of the pump,
V indicating the drive voltage of the pump,
P and V both being determined based on the second information 2A, and
the function using the target supply flow rate as a parameter.

4. A direct oxidation fuel cell system comprising:
a fuel cell configured to generate power from a fuel and an oxidant gas;
a positive displacement pump for supplying the oxidant gas to the fuel cell;
a pump power supply for supplying drive current to the pump;
an oxidant gas flow conditioning unit for inhibiting pulsation of a discharge pressure of the pump;
a pressure sensor for detecting the discharge pressure of the pump;
a load current sensor for detecting a load current of the fuel cell;
a pump current sensor for detecting the drive current of the pump;
a first memory for storing first information relating to a target supply flow rate of the oxidant gas to be supplied to the fuel cell, the rate set based on the load current;
a second memory 2B for storing second information 2B relating to a relation among the drive current of the pump, the discharge pressure of the pump, and the target supply flow rate; and
a controller for controlling a supply flow rate of the oxidant gas being supplied to the fuel cell, the control based on the first information, the second information 2B, a value obtained by the pressure sensor, a value obtained by the load current sensor, and a value obtained by the pump current sensor.

5. The direct oxidation fuel cell system in accordance with claim 4,
wherein the controller adjusts the drive current of the pump, such that a value calculated for the discharge pressure of the pump matches the valued obtained by the pressure sensor,
the calculation comprising: setting the target supply flow rate based on the load current, with use of the first information; and then calculating the value for the discharge pressure, based on the target supply flow rate that is set, with use of the second information 2B.

6. The direct oxidation fuel cell system in accordance with claim 4,
wherein a relation between P and IP is represented by a function P=c×IP−d, where c and d are constants,
P indicating the discharge pressure of the pump,
IP indicating the drive current of the pump,
P and IP both being determined based on the second information 2B, and
the function using the target supply flow rate as a parameter.

7. The direct oxidation fuel cell system in accordance with claim 1, wherein the first information comprises a function for increasing stepwise the target supply flow rate, in accordance with increase in the load current.

8. The direct oxidation fuel cell system in accordance with claim 1, wherein the oxidant gas flow conditioning unit includes a buffer chamber.

9. The direct oxidation fuel cell system in accordance with claim 8, wherein the pressure sensor detects a pressure in the buffer chamber.
